(19) United States
(12) Patent Application Publication
(10) Pub. No.: US 2026/0352843 A1
(43) Pub. Date: Nov. 5, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US); Peking University, Beijing (CN)

(72) Inventors: Huiwen REN, Beijing (CN); Jiexi Wang, Beijing (CN); Zhao Wang, Beijing (CN); Yuwen He, Los Angeles, CA (US); Siwei Ma, Beijing (CN); Li Zhang, Los Angeles, CA (US)

(21) Appl. No.: 19/724,627

(22) Filed: Jun. 29, 2026

Related U.S. Application Data
(63) Continuation of application No. PCT/CN2024/143329, filed on Dec. 27, 2024.

(30) Foreign Application Priority Data
Dec. 29, 2023 (WO) PCT/CN2023/143378

(51) Int. Cl. H04N 19/149; H04N 19/154

(52) U.S. Cl. CPC H04N 19/149; H04N 19/154

(57) ABSTRACT

Embodiments of the disclosure provide a solution for video processing. A method for video processing is proposed. The method includes: determining, for a conversion between a video unit of a video and a bitstream of the video, whether a reconstructed quality of the video unit exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; and performing the conversion based on the adjusted parameter.

### CROSS-REFERENCE TO RELATED APPLICATIONS

This application is a continuation of International Application No. PCT/CN2024/143329, filed on Dec. 27, 2024, which claims the benefit of International Application No. PCT/CN2023/143378, filed on Dec. 29, 2023. The entire contents of these applications are hereby incorporated by reference in their entireties.

### FIELDS

Embodiments of the present disclosure relates generally to video processing techniques, and more particularly, to adaptive bitrate adjustment based on boundary reconstruction quality.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, whether a reconstructed quality of the video unit exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; and performing the conversion based on the adjusted parameter. In this way, the coding performance and coding efficiency can be improved. Further, it ensures that coding quality of the video is within a suitable coding quality range.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises determining whether a reconstructed quality of a video unit of the video exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; and generating the bitstream based on the adjusted parameter.

In a fifth aspect, a method for storing a bitstream of a video is proposed. The method comprises: determining whether a reconstructed quality of a video unit of the video exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; generating the bitstream based on the adjusted parameter; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of layered coding structure in accordance with some embodiments of the present disclosure;

FIG. 5 illustrates a schematic diagram of coding performance in accordance with some embodiments of the present disclosure;

FIG. 6 illustrates a flowchart of a method for video processing in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

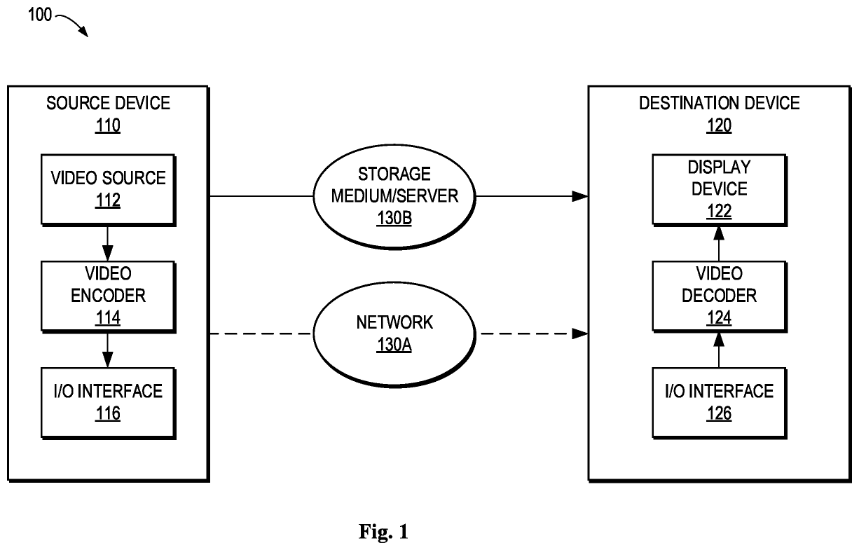

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

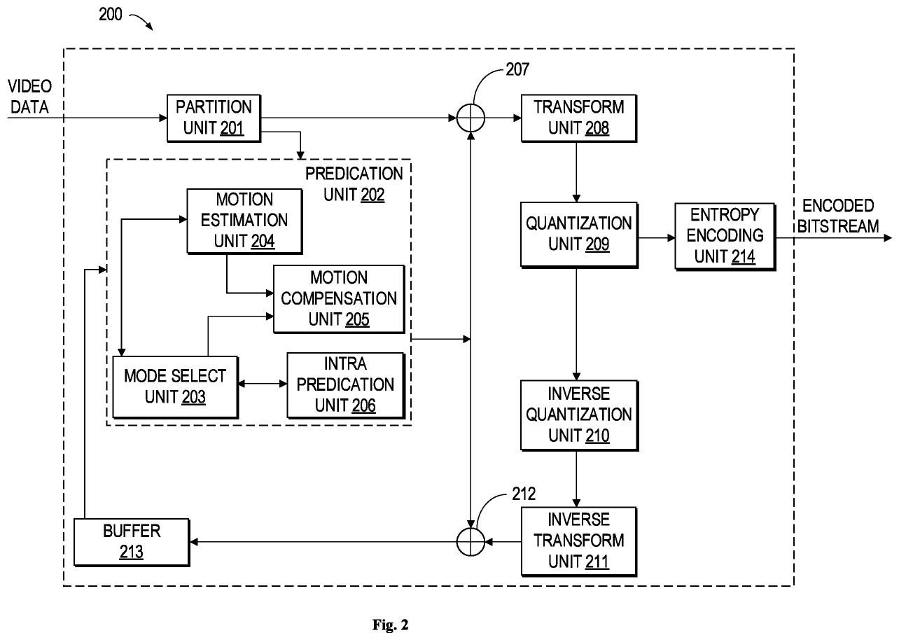

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

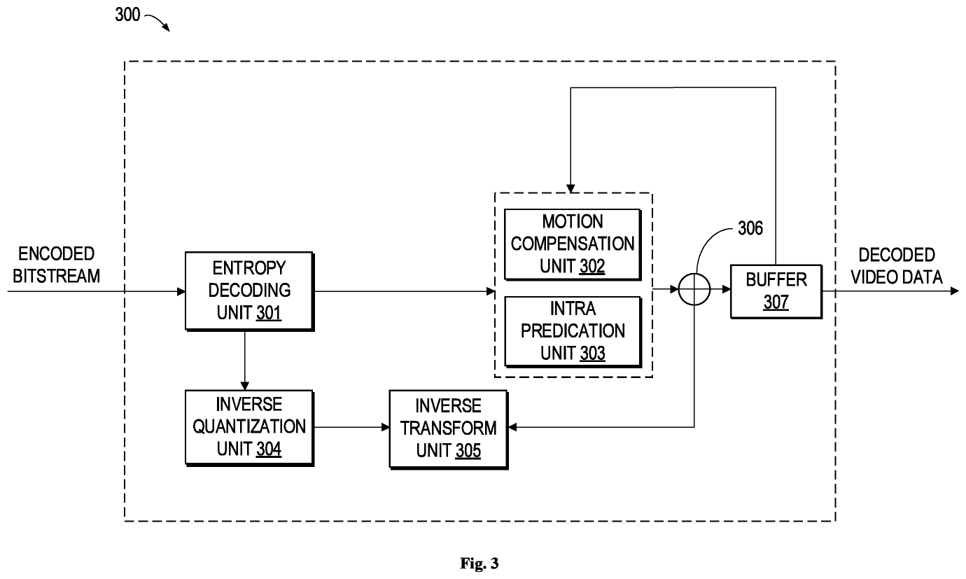

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Introduction

In recent years, with the rapid development of multimedia technology and the increasing popularity of video streaming services, the demand for high-quality video encoding has become crucial. Video encoding is the process of converting raw video data into a compressed format suitable for transmission and storage. However, due to the limited bandwidth and storage capacity, it is essential to ensure efficient compression without compromising the quality of reconstructed videos. To address such challenge, researchers and engineers have developed numerous video coding standards such as H.264, H.265, and AV1. Those standards employ various compression techniques, including spatial and temporal redundancy removal, quantization, and entropy coding. While these standards have significantly improved video compression efficiency, the quality of the compressed video can still be affected by several factors, including the complexity of the video content, transmission errors, and bandwidth limitations.

To overcome those limitations, the development of video encoding quality control algorithms has become an active area of research. These algorithms aim to optimize the trade-off between compression efficiency and video quality by adaptively adjusting encoding parameters based on specific quality metrics (such as PSNR, SSIM, VMAF and VQScore). By considering human visual perception characteristics, those algorithms can allocate more bits to important regions of the video while reducing the bitrate for less important regions, resulting in improved perceptual quality.

Traditional bitrate control methods mainly focus on the convergence of the number of coded words relative to the target value within a certain time range. Hence, the deviation between the average bitrate and the target bitrate in unit time, in order to transmit as much information as possible under limited bandwidth conditions. The obvious drawback of such techniques is the inability to react to the reconstruction quality of the signal, only focusing on the mapping relationship between content and bitrate.

One typical constant quality encoding method is the Constant Rate Factor (CRF) method in the H.264/H.265 encoding standards, which achieves a nearly linear proportional relationship between the quality control factor and the objective reconstruction quality through the analysis of motion characteristics in the encoding region and the fitting derivation of compression characteristics in the already encoded region. The advantage of this method is that the adopted model has strong adaptability, but the drawback is that quality control is relative quality, and the reconstruction quality may vary on different sequences, meaning that the same constant quality factor cannot guarantee the same quality of the encoded stream in different video sequences.

Another advanced constant quality encoding scheme in the field allows for specifying absolute quality. The specific method is to establish a mapping relationship between distortion and the Lagrange multiplier lambda in the rate-distortion decision process during the encoding process, and then derive the quantization parameters for the actual encoding process. This scheme introduces the mapping relationship between distortion and bitrate on the mature R-lambda-QP decision model, and dynamically updates the model parameters at the LCU (largest coding unit) and frame levels. The advantage of this method is that it can maintain good compression performance under the premise of approaching the given absolute quality, but the disadvantage is that the model can only be repaired through continuous encoding quality feedback and can not perform interval quality adjustment on the encoded content.

In addition, there are also some deep learning-based works that aim to achieve stability in both quality and bitrate. However, due to the continuous variation of the signal itself, such algorithms often require high computational complexity, a large amount of prior information, and pre-analysis information, making it difficult to apply in practical application scenarios.

In conclusion, the development of video encoding quality control algorithms is crucial for achieving high-quality video streaming with efficient compression. These algorithms consider perceptual quality metrics, adaptively adjust encoding parameters, and employ various techniques to optimize the trade-off between compression efficiency and video quality. With further advancements in this field, we can expect even better video encoding technologies that offer superior visual experiences to users.

The present disclosure is proposed to introduce a bitrate control method that adaptively restricts the boundary quality of video encoding. It achieves the control of encoding bitrate for a given boundary quality at an extremely low computational complexity. The main feature is making bitrate adjustments to coding intervals that exceed a predetermined upper quality limit or fall below a predetermined lower quality limit, without significantly interfering with the coding strategy within the interval. The primary goal of this method is to further reduce bitrate consumption or quality degradation on the basis of any existing bitrate control functionality by adding restrictive adjustments to the maximum or minimum boundary quality of the existing bitrate control strategy.

Specifically, a method according to the present disclosure models the input signal in the pre-analyzed (lookahead) region that is perceptible to the encoder. It adjusts the frame-level encoding parameters by mapping pre-analyzed distortion to an estimated value of actual encoding distortion. Furthermore, it applies secondary offsets to encoding parameters based on the actual reconstruction quality errors over a certain time period. Note that the proposed method does not rely on any specific pre-analysis algorithm or encoding architecture. It is applicable to any compression scheme that allows rate and quality adjustments through encoding parameters.

### 2. Proposed Solutions

### 2.1. Pre-Analyzed Encoding Cost (PEC)

Pre-analysis Encoding Cost refers to the calculation of the potential redundancy in the temporal and spatial domain of a signal by simulating the encoding behavior on the uncompressed signal. This is achieved through simplified coding unit partitioning, intra-frame encoding, motion estimation, and optional transform/quantization. The pre-analysis cost is used to estimate the encoding cost caused by quantization in the actual encoding process, which typically includes bit cost and reconstruction distortion.

### 2.2. Mean Pre-analysis Error (MPE)

Mean Pre-analysis Error refers to the difference or ratio between the pre-analysis error (PEC) and the actual reconstruction error over a set of encoded frames. Typically, when computing the average pre-analysis error, the encoded frames are clustered based on their characteristics, such as temporal hierarchal layer, prediction type or reference depth. Such as:

$${Err}_{MPE , L} = {\sum }_{k = 1}^{N} \frac{{Cost}_{PEC , k}}{{Cost}_{act , k}} \times \text{?} ( f ( k ) = L ) \qquad ( 1 )$$

where Err_{MPE,L} stands for the MPE of class L in each time period N, Cost_{PEC,k} stands for the PEC of frame k, Cost_{act,k} stands for the actual encoding cost of frame k, and Π(⋅) is the indicator function.

### 2.3. Mean Reconstruction Quality Error (MRQE)

Mean Reconstruction Quality Error refers to the difference between reconstruction quality and given target quality.

Err_{MRQE}=α·(F(Cost_{act})−F(Cost₀))+β (2)

where F(Cost_{act}) stands for the actual reconstruction quality, F(Cost₀) stands for the target reconstruction quality, and α and β are model coefficients.

Note that Equ. (2) is an example of a linear mode. Depending on different encoding frameworks, exponential functions, logarithmic functions, and n-th degree functions are also applicable.

### 2.4. Mean Quantization-Quality Ratio (MQQR)

Mean Quantization-Quality Ratio refers to the ratio between quantization parameter and actual reconstruction quality, which is supposed to get adaptively updated.

$${R}_{Q , N} = {η}_{0} \cdot {\sum }_{k = 1}^{N - 1} ( \frac{{QP}_{k}}{F ( {Cost}_{k} )} ) + \frac{{η}_{1} \cdot {QP}_{N}}{F ( {Cost}_{N} )} \qquad ( 3 )$$

where F(Costₖ) stands for the actual reconstruction quality of frame k, QP stands for the employed quantization parameter or any equivalent parameter used to adjust the quantization performance, and η₀ and η₁ are model coefficients.

### 2.5. Detailed Solutions

The method described herein achieves adaptive adjustment of encoding parameters for subsequent time periods based on statistical analysis of the average reconstruction quality over a certain time period. Additionally, it involves more precise adjustment by constructing a mapping model that correlates pre-analyzed distortion with actual distortion under different encoding configurations. The method comprises the following steps:

Step 1. Construct a bidirectional prediction model between “quality-rate control parameters” to fit the impact of rate control parameters on quality. Quality refers to quantifiable objective metrics like PSNR, MSE, SSIM, while rate control parameters are encoding parameter sets controlling rate allocation, such as quantization parameters and frame types. Thus, the model may consist of multiple output types and is not limited to a single mapping model.

Step 2. Set boundary quality and initialize the bidirectional mapping model from step 1. Initialization includes setting model parameters for quality evaluation and determining the adjustment direction of rate control parameters based on the boundary type (upper or lower) along with the base offset of rate control parameters for the first time period.

Step 3. Within a given time period, pre-analyze a certain number of frames to construct motion information for different encoding regions by partitioning frames into coding units of specific sizes and shapes. These specific sizes and shapes may include, but are not limited to, rectangular blocks ranging from 4×4 to 128×128. Obtaining motion information involves examining all coding units within their available reference regions and selecting the reference position with the minimum prediction cost as the motion vector for each coding unit. Prediction cost is computed by evaluating the pixel differences or quantized differences between the coding unit and the reference unit as the prediction distortion. The prediction distortion and the entropy-coded differences or quantized differences serve as the encoding cost. The weighted sum of prediction distortion and encoding cost determines the reference cost for each prediction position.

Step 4. Based on the motion information obtained in step 3, categorize the encoding frames into coding levels according to their encoding hierarchy. Each coding level maintains a set of mapping models from root mean square of predicted differences to actual reconstructed quality and undergoes initialization. Coding levels generally correspond to temporal reference levels in typical coding models, where the key frame is the first level and the levels for inter-frame references are determined by the maximum reference level within the reference range plus one. Coding levels can also be determined by frame types or other frame characteristics. The mapping models may include, but are not limited to, univariate function models such as linear or logarithmic functions. The initialization of mapping models involves setting default parameters based on probability models that satisfy the relationship between output indicators and actual indicators. The output indicators can be PSNR, MSE, SSIM, or other selected indicators in the defined model.

Step 5. Compute the estimated reconstruction quality for the current encoding frame based on the predicted residual mapping obtained in step 4.

Step 6. Employ the bidirectional mapping model defined in step 1 to derive frame-level adjustment quantities for rate control parameters based on the estimated values obtained in step 5. The actual adjustment quantities for rate control parameters are obtained by adding the base adjustment quantities for the current time period to the frame-level adjustment quantities. Adjustments should be performed separately for each boundary, such as rate suppression for content exceeding the upper boundary or rate supplementation for content below the lower boundary.

Step 7. Update the rate control parameters based on the actual adjustment quantities obtained in step 6 and perform encoding using the updated rate control parameters.

Step 8. Update the mapping model parameters in steps 1 and 4 based on the encoding results obtained in step 7. The update can be achieved by adjusting the model parameters at a certain rate or further scaling the offset for the adjustment quantities of rate control parameters after fixing the model parameters.

Step 9. Repeat steps 5 to 8 until all frames within the current time period are encoded. Multiple asynchronous processing paths are allowed, meaning the model parameters do not need to be updated sequentially based on input or output.

Step 10. Compute the average reconstruction quality for all frames within the current time period. Based on the bidirectional prediction model from step 1, derive the base offset of rate control algorithm parameters and update it at a certain rate as the base offset for the next time period.

Step 11. Repeat steps 3 to 10 until all input images are encoded.

### 2.6 Example Embodiment

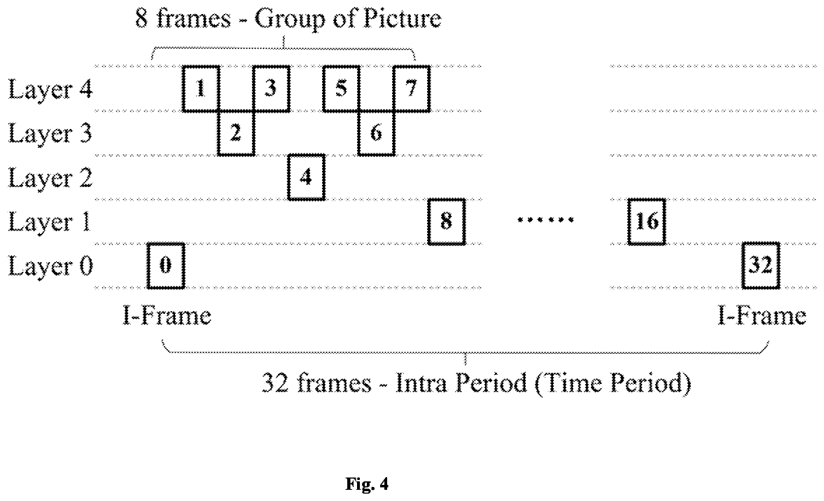

FIG. 4 shows a schematic diagram of layered coding structure according to some embodiments of the present discourse.
1. The 30 Hz frequency video input signal is split into time units of 1 second and aligned to the nearest power of 2, specifically with 32 frames as a time period.
2. A 3-level hierarchical structure for encoding frames is constructed, where the reference structure is divided consecutively three times using binary partitioning (each group consisting of 2\hat{ }3 frames). The 32-frame time period is split into 4 groups of 8 frames each. The first frame in each group can be either an intra-frame encoded frame (I-frame) or a unidirectional inter-frame encoded frame (P-frame), while the rest are bidirectional inter-frame encoded frames (B-frames). Only the first frame in each time period can be an intra-frame encoded frame (I-frame).
3. Initially, both the base rate control parameter offset, and the frame-level rate control parameter offset are set to 0. The quality control boundary is set as the quality upper bound of PSNR=42.5 dB. The rate control scheme utilizes the Constant Rate Factor (CRF) method.
4. Perform encoding distortion estimation with a pre-analysis depth of 8 frames and record the PEC of the residual after motion compensation for each frame.
5. Encode according to the order of the reference structure after frame-level partitioning and use a MPE model to derive the coding distortion from the pre-analyzed distortion, obtaining an estimated coding distortion.
6. Based on MRQE, if the coding distortion is lower than the target distortion (exceeding the quality upper bound), derive the offset of the quantization parameter (QP) based on MRRQ.
7. Encode using the derived offset for the quantization parameter.
8. Based on the difference between the actual reconstruction distortion obtained after encoding and the PEC, update MPE in step 5 with a 20% update rate.
9. Repeat steps 4 to 8 to complete the encoding of four groups of images in the current time period.
10. Calculate the average reconstruction quality of the current time group, calculate the deviation between current quality and the target quality, use a CRF-based MOOR to derive the base offset of the CRF parameter, and update the CRF-related parameters.
11. Repeat steps 4 to 10 until all input images are encoded.

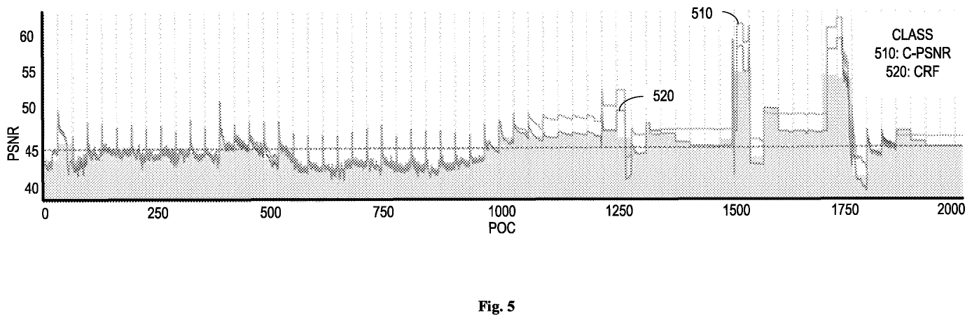

FIG. 5 shows a typical implementation is to use this method to limit the maximum quality to 45 dB and its impact on the encoding performance. The default rate control strategy is CRF=18. In FIG. 5, the curve 510 represents the original encoding quality curve, while the curve 520 represents the encoding quality curve after the quality limitation. The horizontal axis represents the number of encoded frames. It can be observed that when the curve 510 exceeds the quality upper bound of 45 dB, the curve 520 shows a noticeable quality suppression. However, when the curve 510 stays around 45 dB, there is no significant difference in the performance of the curve 520.

### 2.7. Example Solutions

1. By specifying an upper or lower bound for the encoding quality, the encoding content that exceeds the quality boundary is adjusted (including adjustments to the encoding quality derived from pre-analysis for single-pass encoding and adjustments to the known actual quality for multiple encodings). If the reconstructed quality exceeds the specified upper bound, subsequent video segments' encoding parameters are adjusted based on the quality-rate control parameter model to decrease the encoding quality of the subsequent video segments. If the reconstructed quality is lower than the specified lower bound, subsequent video segments' encoding parameters are adjusted based on the quality-rate control parameter model to increase the encoding quality of the subsequent video segments.
2. By specifying an upper or lower bound for the encoding quality, adjustments are made to the encoding content that exceeds the quality boundary by deriving a unified rate control parameter offset over a certain time range.
3. By specifying an upper or lower bound for the encoding quality, adjustments are made to the encoding content that exceeds the quality boundary by deriving rate control parameter offsets based on the encoding level on each frame and historical encoding information.
4. The actual reconstruction distortion is estimated based on the pre-analyzed encoding distortion.
5. The model parameters of the quality-rate control parameter model are updated based on the results of the encoding.
6. Interval adjustments are made to the rate control or other encoding strategies based on the estimated quality.

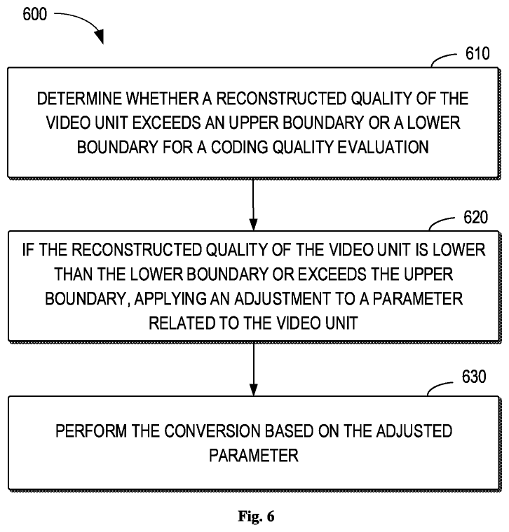

FIG. 6 illustrates a flowchart of a method 600 for video processing in accordance with embodiments of the present disclosure. The method 600 is implemented during a conversion between a video unit of a video and a bitstream of the video.

At block 610, for a conversion between a video unit of a video and a bitstream of the video, whether a reconstructed quality of the video unit exceeds an upper boundary or a lower boundary for a coding quality evaluation is determined. For example, the upper boundary and/or the lower boundary for may refer to quality control boundary. In some embodiments, the upper boundary and/or the lower boundary may include a quality metric, such as, one of: peak signal-to-noise ratio (PSNR), structural similarity index (SSIM), video multimethod assessment fusion (VMAF) or video quality score (VQScore).

At block 620, if the reconstructed quality of the video unit is lower than the lower boundary or exceeds the upper boundary, an adjustment is applied to a parameter related to the video unit.

At block 630, the conversion is performed based on the adjusted parameter. In some embodiments, the conversion includes encoding the video unit into the bitstream. In some other embodiments, the conversion includes decoding the video unit from the bitstream. In this way, the coding performance and coding efficiency can be improved. Further, it ensures that coding quality of the video is within a suitable coding quality range.

In some embodiments, if the reconstructed quality exceeds the upper bound, the parameter is adjusted based on a quality-rate control parameter model to decrease a coding quality of a subsequent video unit. In some other embodiments, if the reconstructed quality is lower the lower bound, the parameter is the parameter is adjusted based on a quality-rate control parameter model to increase a coding quality of a subsequent video unit.

In some embodiments, adjustments are made to a coding content of the video unit by deriving a unified rate control parameter offset over a certain time range. In some other embodiments, adjustments are made to a coding content of the video unit by deriving a rate control parameter offset based on a coding level on each picture and historical coding information.

In some embodiments, an actual reconstruction distortion of the video unit is estimated based on a pre-analyzed distortion. For example, the actual reconstruction distortion is estimated by deriving a coding distortion from the pre-analyzed distortion using a mean pre-analysis error (MPE). As an example, the MPE is obtained by:

$${Err}_{MPE , L} = {\sum }_{k = 1}^{N} \frac{{Cost}_{PEC , k}}{{Cost}_{act , k}} \times \text{?} ( f ( k ) = L ) ,$$

where Err_{MPE,L} represents MPE of class L in each time period N, Cost_{PEC,k} represents a pre-analysis error (PEC) of picture k, Cost_{act,k} represents an actual coding cost of picture k, and Π(⋅) represents an indicator function.

In some embodiments, the method 600 further comprises: determining whether the actual reconstruction distortion is lower than the lower boundary or exceeds the upper boundary based on a mean reconstruction quality error (MRQE). In this case, if the actual reconstruction distortion is lower than the lower boundary or exceeds the upper boundary, an offset of the parameters is derived based on a mean quantization quality ratio (MQQR). For example, the MRQE is obtained by

ETT_{MRQE}=α·(F(Cost_{act})−F(Cost₀))+β,

where F(Cost_{act}) represents the actual reconstruction quality, F(Cost₀) represents a target reconstruction quality, and α and β represents model coefficients.

In some embodiments, the MQQR is obtained by:

$${R}_{Q , N} = {η}_{0} \cdot {\sum }_{k = 1}^{N - 1} ( \frac{{QP}_{k}}{F ( {Cost}_{k} )} ) + \frac{{η}_{1} \cdot {QP}_{N}}{F ( {Cost}_{N} )} ,$$

where F(Costₖ) represents an actual reconstruction quality of picture k, QP represents an employed quantization parameter or an equivalent parameter used to adjust quantization performance, and η₀ and η₁ represents model coefficients.

In some embodiments, one or more parameters of a quality-rate control parameter model are updated based on a result of coding. In some other embodiments, an interval adjustment is made to a rate control or other coding strategies based on an estimated quality of the video unit.

In some embodiments, a bidirectional prediction model between quality-rate control parameters is constructed. For example, the bidirectional prediction model is initialized by setting one or more model parameters for quality evaluation and determining an adjustment direction of a rate control parameter based on a boundary type along with a base offset of the rate control parameter for a first time period. In some embodiments, the upper boundary and the lower boundary are for the coding quality evaluation.

In some embodiments, the method 600 further comprises: pre-analyzing a plurality of pictures of the video unit within the first time period by partitioning the plurality of pictures into coding units; and obtaining motion information for different coding regions based on the pre-analyzing. For example, obtaining the motion information may include: examining each coding unit with its available reference regions; and selecting a reference position with a minimum prediction cost as a motion vector for each coding unit.

In some embodiments, a prediction cost for a coding unit is determined by evaluating pixel differences or quantized differences between the coding unit and a reference unit as a prediction distortion. In some embodiments, the prediction distortion and entropy-coded differences or quantized differences serve as a coding cost. In some embodiments, a weighted sum of prediction distortion and coding cost determines a reference cost for each prediction position.

In some embodiments, the method 600 further comprises: categorizing, based on the motion information, the plurality of pictures into coding levels according to coding hierarchy of the plurality of pictures. In some embodiments, each coding level maintains a set of mapping models from root mean square of predicted differences to actual reconstructed quality and undergoes initialization. For example, an initialization of the set of mapping models comprises setting default parameters based on probability models that satisfy a relationship between an output indicator and an actual indicator.

In some embodiments, the coding levels correspond to temporal reference levels in coding models, a key picture of the plurality of pictures is a first level of the coding levels, and one or more levels for inter-frame references are determined by a maximum reference level within a reference range plus one. In some other embodiments, the coding levels are determined by frame types or other frame characteristics.

In some embodiments, for each picture within a current time period, an estimated reconstruction quality for a current coding picture is determined based on a predicted residual mapping. In some embodiments, a frame-level adjustment quantity for a rate control parameter is derived based on the estimated reconstruction quality using the bidirectional prediction model, and wherein an actual adjustment quantity for the rate control parameter is obtained by adding a base adjustment quantity for the current time period to the frame-level adjustment quantity. In some embodiments, the rate control parameter is updated based on the actual adjustment quantity, and the coding is performed using the updated rate control parameter.

In some embodiments, parameters of the set of mapping models are updated based on a result of the coding. For example, the parameters of the set of mapping models are updated by adjusting the parameters at a rate or further scaling an offset for the adjustment quantity of rate control parameter after fixing the parameters.

In some embodiments, an average reconstruction quality for all pictures within the current time period is determined. In some embodiments, a base offset of rate control parameter is derived based on the bidirectional prediction model. In some embodiments, the base offset of rate control parameter is updated a rate as a base offset for a subsequent time period.

According to further embodiments of the present disclosure, a non-transitory computer-readable recording medium is provided. The non-transitory computer-readable recording medium stores a bitstream of a video which is generated by a method performed by an apparatus for video processing. The method comprises: comprises determining whether a reconstructed quality of a video unit of the video exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; and generating the bitstream based on the adjusted parameter.

According to still further embodiments of the present disclosure, a method for storing bitstream of a video is provided. The method comprises: determining whether a reconstructed quality of a video unit of the video exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; generating the bitstream based on the adjusted parameter; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, whether a reconstructed quality of the video unit exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; and performing the conversion based on the adjusted parameter.

Clause 2. The method of clause 1, wherein in accordance with a determination that the reconstructed quality exceeds the upper bound, the parameter is adjusted based on a quality-rate control parameter model to decrease a coding quality of a subsequent video unit.

Clause 3. The method of clause 1, wherein in accordance with a determination that the reconstructed quality is lower the lower bound, the parameter is the parameter is adjusted based on a quality-rate control parameter model to increase a coding quality of a subsequent video unit.

Clause 4. The method of clause 1, wherein adjustments are made to a coding content of the video unit by deriving a unified rate control parameter offset over a certain time range.

Clause 5. The method of clause 1, wherein adjustments are made to a coding content of the video unit by deriving a rate control parameter offset based on a coding level on each picture and historical coding information.

Clause 6. The method of clause 1, wherein an actual reconstruction distortion of the video unit is estimated based on a pre-analyzed distortion.

Clause 7. The method of clause 6, wherein the actual reconstruction distortion is estimated by deriving a coding distortion from the pre-analyzed distortion using a mean pre-analysis error (MPE).

Clause 8. The method of clause 7, wherein the MPE is obtained by:

$${Err}_{MPE , L} = {\sum }_{k = 1}^{N} \frac{{Cost}_{PEC , k}}{{Cost}_{act , k}} \times \text{?} ( f ( k ) = L ) ,$$

wherein Err_{MPE,L} represents MPE of class L in each time period N, Cost_{PEC,k} represents a pre-analysis error (PEC) of picture k, Cost_{act,k} represents an actual coding cost of picture k, and Π(⋅) represents an indicator function.

Clause 9. The method of clause 7, further comprising: determining whether the actual reconstruction distortion is lower than the lower boundary or exceeds the upper boundary based on a mean reconstruction quality error (MRQE); and in accordance with a determination that the actual reconstruction distortion is lower than the lower boundary or exceeds the upper boundary, deriving an offset of the parameters based on a mean quantization quality ratio (MQQR).

Clause 10. The method of clause 9, wherein the MRQE is obtained by:

ETT_{MRQE}=α·(F(Cost_{act})−F(Cost₀))+β,

wherein F(Cost_{act}) represents the actual reconstruction quality, F(Cost₀) represents a target reconstruction quality, and α and β represents model coefficients.

Clause 11. The method of clause 9, wherein the MQQR is obtained by:

$${R}_{Q , N} = {η}_{0} \cdot {\sum }_{k = 1}^{N - 1} ( \frac{{QP}_{k}}{F ( {Cost}_{k} )} ) + \frac{{η}_{1} \cdot {QP}_{N}}{F ( {Cost}_{N} )} ,$$

wherein F(Costₖ) represents an actual reconstruction quality of picture k, QP represents an employed quantization parameter or an equivalent parameter used to adjust quantization performance, and η₀ and η₁ represents model coefficients.

Clause 12. The method of clause 1, wherein one or more parameters of a quality-rate control parameter model are updated based on a result of coding.

Clause 13. The method of clause 1, wherein an interval adjustment is made to a rate control or other coding strategies based on an estimated quality of the video unit.

Clause 14. The method of clause 1, wherein a bidirectional prediction model between quality-rate control parameters is constructed.

Clause 15. The method of clause 14, wherein the bidirectional prediction model is initialized by setting one or more model parameters for quality evaluation and determining an adjustment direction of a rate control parameter based on a boundary type along with a base offset of the rate control parameter for a first time period, and wherein the upper boundary and the lower boundary are for the coding quality evaluation.

Clause 16. The method of clause 15, further comprising: pre-analyzing a plurality of pictures of the video unit within the first time period by partitioning the plurality of pictures into coding units; and obtaining motion information for different coding regions based on the pre-analyzing.

Clause 17. The method of clause 16, wherein obtaining the motion information comprises: examining each coding unit with its available reference regions; and selecting a reference position with a minimum prediction cost as a motion vector for each coding unit.

Clause 18. The method of clause 17, wherein a prediction cost for a coding unit is determined by evaluating pixel differences or quantized differences between the coding unit and a reference unit as a prediction distortion, and wherein the prediction distortion and entropy-coded differences or quantized differences serve as a coding cost, and wherein a weighted sum of prediction distortion and coding cost determines a reference cost for each prediction position.

Clause 19. The method of clause 16, further comprising: categorizing, based on the motion information, the plurality of pictures into coding levels according to coding hierarchy of the plurality of pictures.

Clause 20. The method of clause 19, wherein each coding level maintains a set of mapping models from root mean square of predicted differences to actual reconstructed quality and undergoes initialization.

Clause 21. The method of clause 20, wherein an initialization of the set of mapping models comprises setting default parameters based on probability models that satisfy a relationship between an output indicator and an actual indicator.

Clause 22. The method of clause 19, wherein the coding levels correspond to temporal reference levels in coding models, a key picture of the plurality of pictures is a first level of the coding levels, and one or more levels for inter-frame references are determined by a maximum reference level within a reference range plus one.

Clause 23. The method of clause 19, wherein the coding levels are determined by frame types or other frame characteristics.

Clause 24. The method of clause 19, wherein for each picture within a current time period, an estimated reconstruction quality for a current coding picture is determined based on a predicted residual mapping.

Clause 25. The method of clause 24, wherein a frame-level adjustment quantity for a rate control parameter is derived based on the estimated reconstruction quality using the bidirectional prediction model, and wherein an actual adjustment quantity for the rate control parameter is obtained by adding a base adjustment quantity for the current time period to the frame-level adjustment quantity.

Clause 26. The method of clause 25, wherein the rate control parameter is updated based on the actual adjustment quantity, and wherein the coding is performed using the updated rate control parameter.

Clause 27. The method of clause 26, wherein parameters of the set of mapping models are updated based on a result of the coding.

Clause 28. The method of clause 27, wherein the parameters of the set of mapping models are updated by adjusting the parameters at a rate or further scaling an offset for the adjustment quantity of rate control parameter after fixing the parameters.

Clause 29. The method of clause 24, wherein an average reconstruction quality for all pictures within the current time period is determined, wherein a base offset of rate control parameter is derived based on the bidirectional prediction model, and wherein the base offset of rate control parameter is updated a rate as a base offset for a subsequent time period.

Clause 30. The method of any of clauses 1-29, wherein the conversion includes encoding the video unit into the bitstream.

Clause 31. The method of any of clauses 1-29, wherein the conversion includes decoding the video unit from the bitstream.

Clause 32. An apparatus for video processing comprising a processor and a non-transitory memory with instructions thereon, wherein the instructions upon execution by the processor, cause the processor to perform a method in accordance with any of clauses 1-31.

Clause 33. A non-transitory computer-readable storage medium storing instructions that cause a processor to perform a method in accordance with any of clauses 1-31.

Clause 34. A non-transitory computer-readable recording medium storing a bitstream of a video which is generated by a method performed by an apparatus for video processing, wherein the method comprises: determining whether a reconstructed quality of a video unit of the video exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; and generating the bitstream based on the adjusted parameter.

Clause 35. A method for storing a bitstream of a video, comprising: determining whether a reconstructed quality of a video unit of the video exceeds an upper boundary or a lower boundary for a coding quality evaluation; in accordance with a determination that the reconstructed quality of the video unit is lower than the lower boundary or exceeds the upper boundary, applying an adjustment to a parameter related to the video unit; generating the bitstream based on the adjusted parameter; and storing the bitstream in a non-transitory computer-readable recording medium.

### Example Device

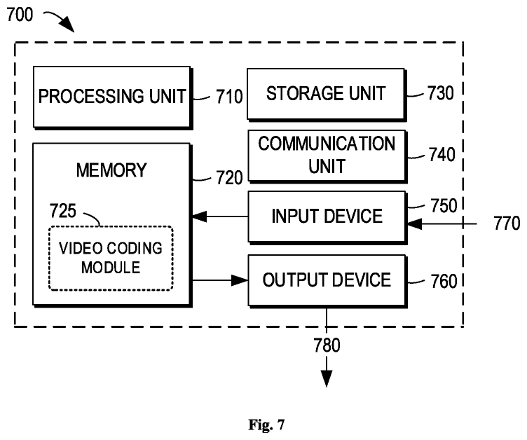

FIG. 7 illustrates a block diagram of a computing device 700 in which various embodiments of the present disclosure can be implemented. The computing device 700 may be implemented as or included in the source device 110 (or the video encoder 114 or 200) or the destination device 120 (or the video decoder 124 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement video encoding/decoding in embodiments of the present disclosure. The memory 720 may include one or more video coding modules 725 having one or more program instructions. These modules are accessible and executable by the processing unit 710 to perform the functionalities of the various embodiments described herein.

In the example embodiments of performing video encoding, the input device 750 may receive video data as an input 770 to be encoded. The video data may be processed, for example, by the video coding module 725, to generate an encoded bitstream. The encoded bitstream may be provided via the output device 760 as an output 780.

In the example embodiments of performing video decoding, the input device 750 may receive an encoded bitstream as the input 770. The encoded bitstream may be processed, for example, by the video coding module 725, to generate decoded video data. The decoded video data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, whether a reconstructed quality of the video unit exceeds an upper boundary or a lower boundary for a coding quality evaluation;
in accordance with a determination that the reconstructed quality of the video unit is lower than the lower boundary or exceeds the upper boundary, applying an adjustment to a parameter related to the video unit; and
performing the conversion based on the adjusted parameter.

2. The method of claim 1, wherein in accordance with a determination that the reconstructed quality exceeds the upper bound, the parameter is adjusted based on a quality-rate control parameter model to decrease a coding quality of a subsequent video unit, and/or
wherein in accordance with a determination that the reconstructed quality is lower the lower bound, the parameter is the parameter is adjusted based on a quality-rate control parameter model to increase a coding quality of a subsequent video unit, and/or
wherein adjustments are made to a coding content of the video unit by deriving a unified rate control parameter offset over a certain time range, and/or
wherein adjustments are made to a coding content of the video unit by deriving a rate control parameter offset based on a coding level on each picture and historical coding information, and/or
wherein an actual reconstruction distortion of the video unit is estimated based on a pre-analyzed distortion.

3. The method of claim 2, wherein the actual reconstruction distortion is estimated by deriving a coding distortion from the pre-analyzed distortion using a mean pre-analysis error (MPE).

4. The method of claim 3, wherein the MPE is obtained by:
$${Err}_{MPE , L} = {\sum }_{k = 1}^{N} \frac{{Cost}_{PEC , k}}{{Cost}_{act , k}} \times \text{?} ( f ( k ) = L ) ,$$
wherein Err_{MPE,L} represents MPE of class L in each time period N, Cost_{PEC,k} represents a pre-analysis error (PEC) of picture k, Cost_{act,k} represents an actual coding cost of picture k, and Π(⋅) represents an indicator function.

5. The method of claim 3, further comprising:
determining whether the actual reconstruction distortion is lower than the lower boundary or exceeds the upper boundary based on a mean reconstruction quality error (MRQE); and
in accordance with a determination that the actual reconstruction distortion is lower than the lower boundary or exceeds the upper boundary, deriving an offset of the parameters based on a mean quantization quality ratio (MQQR).

6. The method of claim 5, wherein the MRQE is obtained by:
ETT_{MRQE}=α·(F(Cost_{act})−F(Cost₀))+β,
wherein F(Cost_{act}) represents the actual reconstruction quality, F(Cost₀) represents a target reconstruction quality, and α and β represents model coefficients.

7. The method of claim 5, wherein the MQQR is obtained by:
$${R}_{Q , N} = {η}_{0} \cdot {\sum }_{k = 1}^{N - 1} ( \frac{{QP}_{k}}{F ( {Cost}_{k} )} ) + \frac{{η}_{1} \cdot {QP}_{N}}{F ( {Cost}_{N} )} ,$$
wherein F(Costₖ) represents an actual reconstruction quality of picture k, QP represents an employed quantization parameter or an equivalent parameter used to adjust quantization performance, and η₀ and η₁ represents model coefficients.

8. The method of claim 1, wherein one or more parameters of a quality-rate control parameter model are updated based on a result of coding, and/or
wherein an interval adjustment is made to a rate control or other coding strategies based on an estimated quality of the video unit, and/or
wherein a bidirectional prediction model between quality-rate control parameters is constructed.

9. The method of claim 8, wherein the bidirectional prediction model is initialized by setting one or more model parameters for quality evaluation and determining an adjustment direction of a rate control parameter based on a boundary type along with a base offset of the rate control parameter for a first time period, and
wherein the upper boundary and the lower boundary for the coding quality evaluation.

10. The method of claim 9, further comprising:
pre-analyzing a plurality of pictures of the video unit within the first time period by partitioning the plurality of pictures into coding units; and
obtaining motion information for different coding regions based on the pre-analyzing.

11. The method of claim 10, wherein obtaining the motion information comprises:
examining each coding unit with its available reference regions; and
selecting a reference position with a minimum prediction cost as a motion vector for each coding unit, and/or
wherein the method further comprises:
categorizing, based on the motion information, the plurality of pictures into coding levels according to coding hierarchy of the plurality of pictures.

12. The method of claim 11, wherein a prediction cost for a coding unit is determined by evaluating pixel differences or quantized differences between the coding unit and a reference unit as a prediction distortion, and
wherein the prediction distortion and entropy-coded differences or quantized differences serve as a coding cost, and
wherein a weighted sum of prediction distortion and coding cost determines a reference cost for each prediction position, and/or
wherein each coding level maintains a set of mapping models from root mean square of predicted differences to actual reconstructed quality and undergoes initialization, and/or
wherein the coding levels correspond to temporal reference levels in coding models, a key picture of the plurality of pictures is a first level of the coding levels, and one or more levels for inter-frame references are determined by a maximum reference level within a reference range plus one, and/or
wherein the coding levels are determined by frame types or other frame characteristics, and/or
wherein for each picture within a current time period, an estimated reconstruction quality for a current coding picture is determined based on a predicted residual mapping.

13. The method of claim 12, wherein an initialization of the set of mapping models comprises setting default parameters based on probability models that satisfy a relationship between an output indicator and an actual indicator, and/or
wherein a frame-level adjustment quantity for a rate control parameter is derived based on the estimated reconstruction quality using the bidirectional prediction model, and
wherein an actual adjustment quantity for the rate control parameter is obtained by adding a base adjustment quantity for the current time period to the frame-level adjustment quantity, and/or
wherein an average reconstruction quality for all pictures within the current time period is determined,
wherein a base offset of rate control parameter is derived based on the bidirectional prediction model, and
wherein the base offset of rate control parameter is updated a rate as a base offset for a subsequent time period.

14. The method of claim 13, wherein the rate control parameter is updated based on the actual adjustment quantity, and
wherein the coding is performed using the updated rate control parameter.

15. The method of claim 14, wherein parameters of the set of mapping models are updated based on a result of the coding.

16. The method of claim 15, wherein the parameters of the set of mapping models are updated by adjusting the parameters at a rate or further scaling an offset for the adjustment quantity of rate control parameter after fixing the parameters.

17. The method of claim 1, wherein the conversion includes encoding the video unit into the bitstream, or
the conversion includes decoding the video unit from the bitstream.

18. The method of claim 1, wherein the conversion comprises: generating the bitstream from the video, and
the method further comprises: storing the bitstream in a non-transitory computer-readable recording medium.

19. An apparatus for video processing comprising a processor and a non-transitory memory with instructions thereon, wherein the instructions upon execution by the processor, cause the processor to:
determine, for a conversion between a video unit of a video and a bitstream of the video, whether a reconstructed quality of the video unit exceeds an upper boundary or a lower boundary for a coding quality evaluation;
in accordance with a determination that the reconstructed quality of the video unit is lower than the lower boundary or exceeds the upper boundary, apply an adjustment to a parameter related to the video unit; and
perform the conversion based on the adjusted parameter.

20. A non-transitory computer-readable storage medium storing instructions that cause a processor to:
determine, for a conversion between a video unit of a video and a bitstream of the video, whether a reconstructed quality of the video unit exceeds an upper boundary or a lower boundary for a coding quality evaluation;
in accordance with a determination that the reconstructed quality of the video unit is lower than the lower boundary or exceeds the upper boundary, apply an adjustment to a parameter related to the video unit; and
perform the conversion based on the adjusted parameter.
